(19) United States
(12) Patent Application Publication
(10) Pub. No.: US 2025/0377215 A1
(43) Pub. Date: Dec. 11, 2025

(54) ACTION SUGGESTION SYSTEM AND ACTION SUGGESTION METHOD

(71) Applicant: HONDA MOTOR CO., LTD., Tokyo (JP)

(72) Inventors: Katsumasa Ishikawa, Wako-shi (JP); Atsushi Kumakura, Wako-shi (JP); Yutaka Yoshida, Wako-shi (JP)

(21) Appl. No.: 19/213,286

(22) Filed: May 20, 2025

(30) Foreign Application Priority Data
Jun. 10, 2024 (JP) 2024-093506

(51) Int. Cl. G01C 21/36; G01C 21/34

(52) U.S. Cl. CPC G01C 21/3697; G01C 21/3423

(57) ABSTRACT

An action suggestion system includes: a free time recognition unit recognizing free time of a user; a free time position recognition unit recognizing a free time starting position being a position at which the user is located when the free time starts; a candidate action selection unit that selects, as a candidate action to be suggested to the user, an action that the user can perform using the free time, the action including travel between the free time starting position and a destination by any of a plurality of travel methods and a predetermined activity at the destination; and a candidate action information provision unit that causes a display device used by the user to display an action suggestion screen displaying a required travel time between the free time starting position and the destination for each of the plurality of travel methods and a content of the predetermined activity.

### INCORPORATION BY REFERENCE

The present application claims priority under 35 U.S.C. § 119 to Japanese Patent Application No. 2024-093506 filed on Jun. 10, 2024. The content of the application is incorporated herein by reference in its entirety.

### BACKGROUND OF THE INVENTION

### Field of the Invention

The present invention relates to an action suggestion system and an action suggestion method.

### Description of the Related Art

In the related art, a schedule management device is proposed that acquires schedule information of a user and detects, when a schedule entry indicating a start time being delayed or an end time being early is present in the schedule information, a difference from an originally scheduled time as free time of the user (for example, see Japanese Patent Laid-Open No. 2020-47200). The schedule management device identifies, in accordance with a length of the detected free time, an action that can be performed within the free time and that relates to an action content of a future schedule entry of the user also taking into account a travel time of the user, and provides the user with action suggestion information suggesting the identified action.

When the user performs an action in the free time involving travel, a remaining time obtained by excluding the travel time from the free time changes in accordance with a required travel time that differs per travel method. As such, the user is assumed to determine an action that matches their wishes by considering the length of the free time, the required travel time, a content of an activity that can be performed in the remaining time obtained by excluding the travel time from the free time, and the like. Such determination of action includes selection of a travel method. However, in the schedule management device described above in the related art, information about a variety of actions in accordance with a difference in travel time depending on travel method is not suggested since the travel method of the user is not taken into account, causing the information about the actions suggested to the user to be insufficient.

The present application has been made in view of the above circumstances and an object thereof is to provide an action suggestion system and an action suggestion method that can suggest actions to the user that can be performed in the free time of the user by extracting the actions in accordance with a difference in travel time depending on the travel method.

### SUMMARY OF THE INVENTION

A first aspect for achieving the above object includes an action suggestion system including: a free time recognition unit that recognizes free time of a user; a free time position recognition unit that recognizes a free time starting position being a position at which the user is located when the free time starts; a candidate action selection unit that selects, as a candidate action to be suggested to the user, an action that the user can perform using the free time, the action including travel between the free time starting position and a destination by any of a plurality of travel methods and a predetermined activity at the destination; and a candidate action information provision unit that causes a display device used by the user to display an action suggestion screen displaying a required travel time between the free time starting position and the destination for each of the plurality of travel methods and a content of the predetermined activity.

The action suggestion system may be configured such that: the free time position recognition unit recognizes a free time ending position being a position at which the user is located when the free time ends; the candidate action selection unit selects, when the free time starting position and the free time ending position are different, an action as the candidate action, the action including travel from the free time starting position to the destination by any of a plurality of first travel methods, the predetermined activity at the destination, and travel from the destination to the free time ending position by any of a plurality of second travel methods; and the candidate action information provision unit causes, when the free time starting position and the free time ending position are different, the display device to display the action suggestion screen displaying a required travel time from the free time starting position to the destination for each of the plurality of first travel methods, a required travel time from the destination to the free time ending position for each of the plurality of second travel methods, and the content of the predetermined activity.

The action suggestion system may be configured such that the candidate action selection unit selects the candidate action by referring to an activity database in which evaluation information about a plurality of target activities is recorded and extracting the predetermined activity from the plurality of target activities having a high rating equal to or higher than a predetermined level.

The action suggestion system may further include an activity purpose recognition unit that recognizes an activity purpose the user desires. The action suggestion system may be configured such that the candidate action selection unit selects the candidate action by referring to an activity database in which an activity purpose of a plurality of target activities is recorded and extracting the predetermined activity from the plurality of target activities the activity purpose of which is recorded, the predetermined activity matching the activity purpose the user desires.

The action suggestion system may be configured such that the candidate action selection unit selects, as an action that the user can perform using the free time, an action that the user can perform within the free time or an action that the user can perform by adding a predetermined amount of time before and/or after the free time.

The action suggestion system may be configured such that, when a first case in which the candidate action can be performed within the free time and a second case in which the candidate action can be performed by adding the predetermined amount of time before and/or after the free time occur due to a difference between the plurality of travel methods, the candidate action information provision unit causes the display device to display the action suggestion screen displaying the travel methods in the first case and the second case together with a required travel time of the travel methods.

The action suggestion system may further include a remaining time monitor unit that recognizes that the user has started the candidate action, monitors a remaining time of the free time at the destination, and causes the display device to display warning information indicating that the remaining time is running short when the remaining time is equal to or shorter than a predetermined determination time.

The action suggestion system may be configured such that the remaining time monitor unit causes the display device to display stay extension suggestion information including a suggestion to extend a stay duration at the destination when the remaining time is equal to or shorter than the determination time and information about the travel methods available when the stay duration at the destination is extended.

The action suggestion system may further include a schedule recognition unit that recognizes a schedule of the user. The action suggestion system may be configured such that the remaining time monitor unit determines whether to cause the display device to display the stay extension suggestion information in accordance with plans of the user after the free time recognized from the schedule.

A second aspect for achieving the above object includes an action suggestion method to be executed by a computer, the action suggestion method including: a free time recognition step of recognizing free time of a user; a free time starting position recognition step of recognizing a free time starting position being a position at which the user is located when the free time starts; a candidate action selection step of selecting, as a candidate action to be suggested to the user, an action that the user can perform using the free time, the action including travel between the free time starting position and a destination by any of a plurality of travel methods and a predetermined activity at the destination; and a candidate action information provision step of causing a display device used by the user to display an action suggestion screen displaying a required travel time between the free time starting position and the destination for each of the plurality of travel methods and a content of the predetermined activity.

According to the action suggestion system and the action suggestion method above, an action can be suggested to the user that can be performed in the free time of the user by extracting the action in accordance with a difference in travel time depending on the travel method.

### BRIEF DESCRIPTION OF THE DRAWINGS

FIG. 1 is an explanatory diagram of a configuration and an operation mode of an action suggestion system;

FIG. 2 is an explanatory diagram of a schedule example of a user;

FIG. 3 is a flowchart of candidate action suggestion processing;

FIG. 4 is an explanatory diagram of a candidate action suggestion screen; and

FIG. 5 is a flowchart of remaining time monitor processing.

### DETAILED DESCRIPTION OF THE INVENTION

### 1. Configuration and Operation Mode of Action Suggestion System

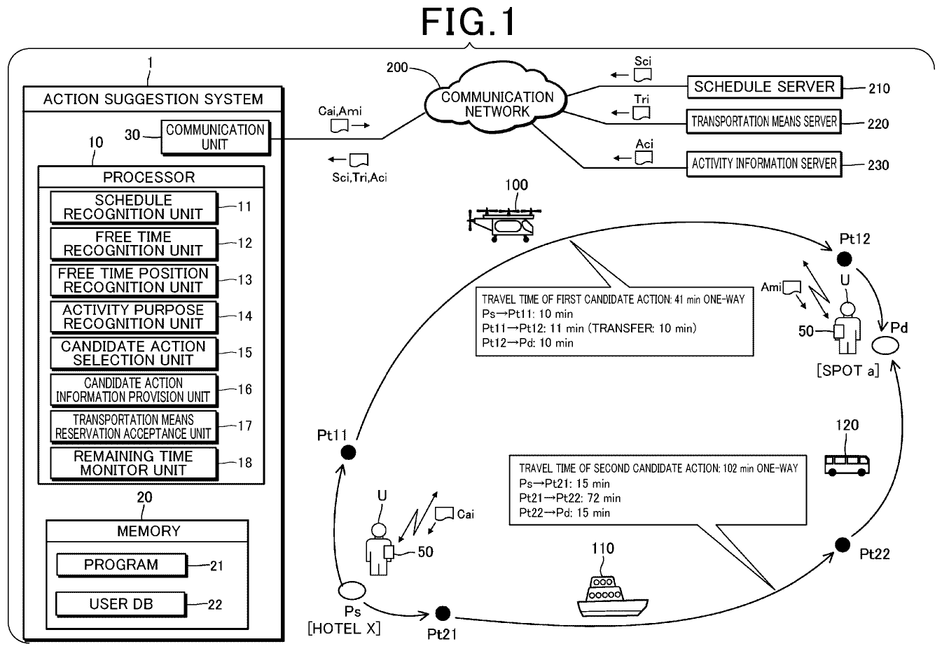

A configuration and an operation mode of an action suggestion system 1 according to the present embodiment will be described with reference to FIG. 1. The action suggestion system 1 provides a user U that uses a service provided by the action suggestion system 1 with information about a candidate action that is an action that can be performed by the user U by using free time of the user U.

The action suggestion system 1 is a computer system including a processor 10, a memory 20, a communication unit 30, and the like. The action suggestion system 1 performs, via a communication network 200, communication with a schedule server 210 (computer), a transportation means server 220 (computer), an activity information server 230 (computer), a user terminal 50 used by the user U, and the like by using the communication unit 30 (transmitter/receiver, circuit).

The user terminal 50 is a communication terminal including a display, such as a smartphone, a mobile phone, or a tablet terminal. The user terminal 50 corresponds to a display device according to the present disclosure. The user U uses an action suggestion app (application program) for using the service provided by the action suggestion system 1 by installing the action suggestion app on the user terminal 50. The action suggestion app receives candidate action information Cai transmitted from the action suggestion system 1 to the user terminal 50, and displays the information about the candidate action included in the candidate action information Cai on the display of the user terminal 50.

The schedule server 210 receives, through the communication with the user terminal 50, schedule information Sci indicating a schedule of the user U input by using a schedule app installed on the user terminal 50 by the user U, and stores the schedule information Sci. The action suggestion system 1 acquires the schedule information Sci of the user U by receiving the schedule information Sci from the schedule server 210.

The transportation means server 220 provides transportation means information Tri relating to a transportation means route, an operation schedule, a fee, and the like. In FIG. 1, an electric vertical take-off and landing (eVTOL) aircraft 100, a ship 110, and a bus 120 are shown as examples of transportation means. An aircraft besides the eVTOL, rail transport, a taxi, and the like are also included in the transportation means. The action suggestion system 1 acquires the transportation means information Tri by receiving the transportation means information Tri from the transportation means server 220.

The activity information server 230 provides activity information Aci relating to various activities (sightseeing, leisure, enjoying scenery, theater, and the like). The action suggestion system 1 acquires the activity information Aci by receiving the activity information Aci from the activity information server 230.

A program 21 for control of the action suggestion system 1, a user database (DB) 22 in which personal information such as a profile of a user (including the user U) that uses the service of the action suggestion system 1 is recorded, and the like are stored in the memory 20 of the action suggestion system 1. The processor 10 functions, by loading and executing the program 21, as a schedule recognition unit 11, a free time recognition unit 12, a free time position recognition unit 13, an activity purpose recognition unit 14, a candidate action selection unit 15, a candidate action information provision unit 16, a transportation means reservation acceptance unit 17, and a remaining time monitor unit 18.

Processing executed by the schedule recognition unit 11, the free time recognition unit 12, the free time position recognition unit 13, the activity purpose recognition unit 14, the candidate action selection unit 15, the candidate action information provision unit 16, the transportation means reservation acceptance unit 17, and the remaining time monitor unit 18 will be described in detail below.

The processing executed by the free time recognition unit 12 corresponds to a free time recognition step in an action suggestion method according to the present disclosure, and the processing executed by the free time position recognition unit 13 corresponds to a free time starting position recognition step in the action suggestion method according to the present disclosure. The processing executed by the candidate action selection unit 15 corresponds to a candidate action selection step according to the present disclosure, and the processing executed by the candidate action information provision unit 16 corresponds to a candidate action information provision step according to the present disclosure.

### 2. Candidate Action Suggestion Processing

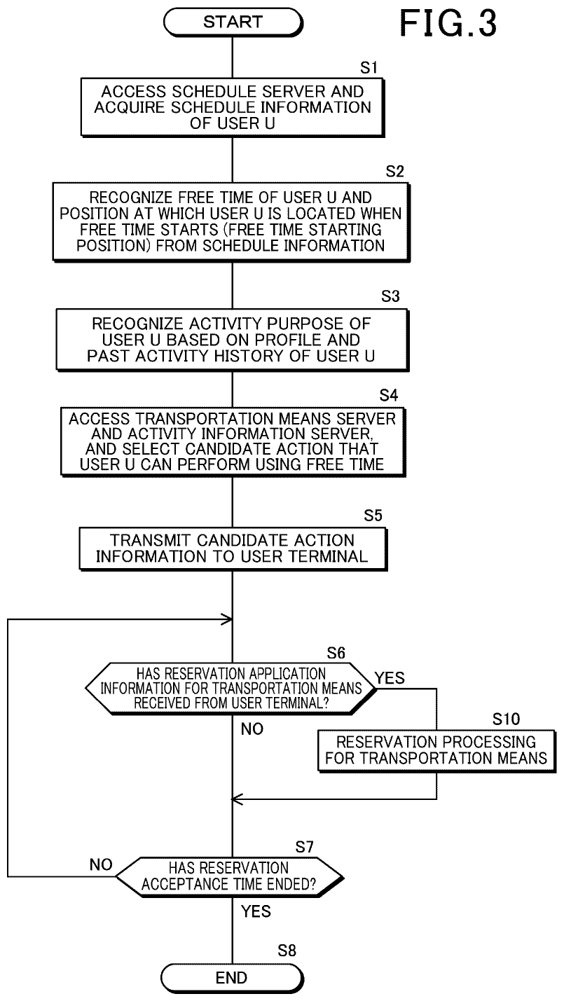

A procedure of candidate action suggestion processing executed by the schedule recognition unit 11, the free time recognition unit 12, the free time position recognition unit 13, the activity purpose recognition unit 14, the candidate action selection unit 15, the candidate action information provision unit 16, and the transportation means reservation acceptance unit 17 will be described in accordance with a flowchart shown in FIG. 3.

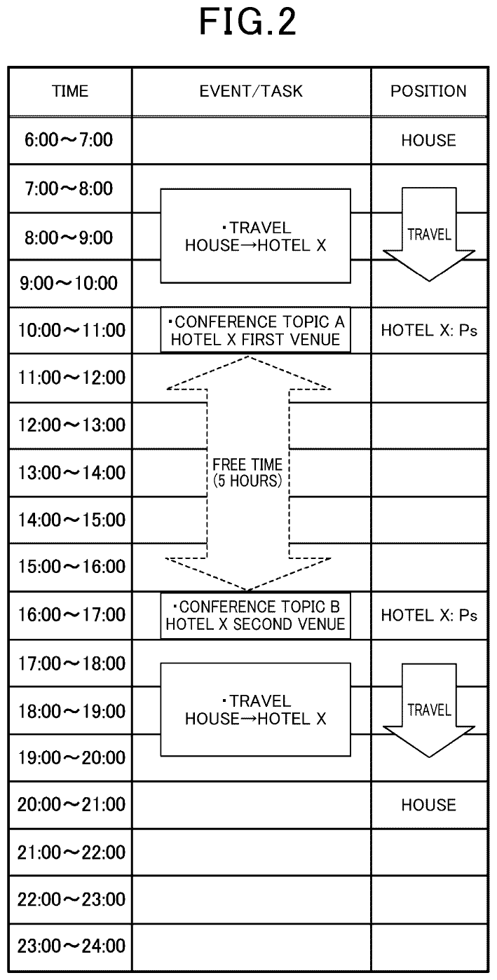

In step S1 of FIG. 3, the schedule recognition unit 11 accesses the schedule server 210, acquires the schedule information Sci of the user U, and recognizes the schedule of the user U from the schedule information Sci. FIG. 2 shows an example of one day in the schedule of the user U, in which the user U has plans to participate in a conference held in Hotel X.

In the schedule of FIG. 2, the user U travels from their house to Hotel X between 7:30 and 9:30, and participates in a conference about Topic A held at a first venue of Hotel X between 10:00 and 11:00. Subsequently, the user U participates in a conference about Topic B held at a second venue of Hotel X between 16:00 and 17:00, and plans to travel from Hotel X to their house between 17:30 and 19:30.

In subsequent step S2, the free time recognition unit 12 recognizes the free time of the user U from the schedule of the user U. In the example of FIG. 2, the free time recognition unit 12 recognizes five hours between 11:00 and 16:00 as the free time of the user U. The free time position recognition unit 13 recognizes a free time monitor position being a position at which the user U is located when the free time of the user U starts. In the example of FIG. 2, the free time position recognition unit 13 recognizes Ps being the location of Hotel X as a free time starting position.

In following step S3, the activity purpose recognition unit 14 recognizes (estimates) an activity purpose estimated to be what the user U wishes to do, based on the profile (hobbies, tastes, age, and the like) of the user U recorded in the user DB 22 and an action history of the user U understood from a past schedule of the user U saved on the schedule server 210. Note that the activity purpose recognition unit 14 may recognize the activity purpose of the user U in accordance with an element other than the profile and the action history of the user U, such as a web browsing history of the user U or the conferences about Topics A and B that the user U will participate in.

In following step S4, the candidate action selection unit 15 selects a candidate action that the user U can perform by using the free time and has Hotel X as a starting point and an ending point, in accordance with the free time of the user U recognized by the free time recognition unit 12 and the free time starting position recognized by the free time position recognition unit 13. The candidate action selection unit 15 accesses the transportation means server 220 and the activity information server 230, and selects, as the candidate action, an action that is suitable for the activity purpose of the user U recognized by the activity purpose recognition unit 14 and that has an evaluation score given by other users equal to or higher than a threshold value. The evaluation score corresponds to evaluation information according to the present disclosure and the threshold value corresponds to a predetermined level according to the present disclosure.

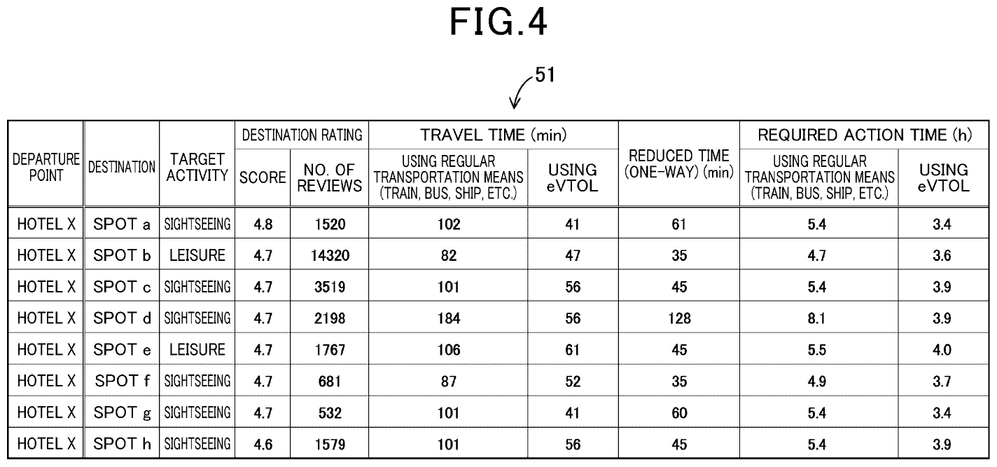

In following step S5, the candidate action information provision unit 16 transmits, to the user terminal 50, the candidate action information Cai relating to the candidate action selected by the candidate action selection unit 15. As shown as an example in FIG. 4, the user terminal 50 displays, on the display, an action suggestion screen 51 indicating information about each candidate action included in the received candidate action information Cai.

As shown in FIG. 4, the action suggestion screen 51 displays, for each candidate action and as a list, a destination, a target activity (predetermined activity to be performed at destination), evaluation information about the destination (evaluation score and number of reviews), a travel time (one-way) from a departure point (Hotel X) to the destination when using transportation means other than an eVTOL such as a ship and when using an eVTOL, reduced time (one-way) when traveling using an eVTOL, and a total required action time of the candidate action when using transportation means other than an eVTOL such as a ship and when using an eVTOL.

The required action time includes travel time on foot, transportation means waiting time, and the like. A usage fee of each transportation means may also be displayed. The candidate action includes a candidate action that can be performed within the free time of the user U and a candidate action that becomes possible to perform by adding a predetermined amount of time to the free time. As such, the user U can compare the required candidate action time, the travel time of the transportation means, the transportation means usage fee, and the like of each candidate action, and select and perform the candidate action that fits their circumstances.

The action suggestion screen 51 displays the candidate actions in descending order of the evaluation score. In FIG. 1, an example of an action suggestion is shown in which the user U travels to a spot a having the highest evaluation score in the action suggestion screen 51 of FIG. 4. FIG. 1 shows an example of a first candidate action in which the user U travels from Ps being the location of Hotel X (free time starting position) to Pd being a location of the spot a (destination) using the eVTOL 100, and a second candidate action in which the user U travels between Ps and Pd using the ship 110 and the bus 120.

In the first candidate action, the user U travels from Ps to a first port Pt11 on foot, travels from the first port Pt11 to a second port Pt12 using the eVTOL 100, and travels from the second port Pt12 to Pd on foot. The user U then returns to Ps in the same way using the eVTOL 100, after performing the target activity (sightseeing) at Pd.

In the second candidate action, the user U travels from Ps to a third port Pt21 on foot, travels from the third port Pt21 to a fourth port Pt22 using the ship 110, and travels from the fourth port Pt22 to Pd using the bus 120. The user U then returns to Ps in the same way using the ship 110 and the bus 120, after performing the target activity (sightseeing) at Pd.

In the second candidate action using the ship 110 and the bus 120, the user U cannot perform the second candidate action within the free time (5 hours) since the required action time is 5.4 hours, and is required to add time before or after the free time. On the other hand, in the first candidate action using the eVTOL 100, the user U can perform the first candidate action within the free time (5 hours) with time to spare since the required action time is 3.4 hours.

In this manner, the user U can: view the action suggestion screen 51; compare the target activity at each destination, the length of the required action time by transportation means to be used for each candidate action, and the usage fee of each transportation means to be used; and determine the candidate action to be performed.

The travel method by walking and the eVTOL 100 in the first candidate action and the travel method by walking, the ship 110, and the bus 120 in the second candidate action are travel methods in which a plurality of travel means are combined, but the travel method according to the present disclosure may also include one travel means. The travel means includes public transportation, car rental, car sharing, the user's own car, walking, and the like.

Following steps S6, S7, and S10 are processing by the transportation means reservation acceptance unit 17. The transportation means reservation acceptance unit 17 determines in step S6 whether reservation application information for a transportation means has been received from the user terminal 50, until a reservation acceptance end time (set a predetermined amount of time before a start time of the free time of the user U, for example) in step S7. The transportation means reservation acceptance unit 17 then proceeds to step S10 when the reservation application information has been received, executes reservation processing for the transportation means (transmission of reservation arrangement information to the transportation means server 220), and proceeds the processing to step S7.

### 3. Remaining Time Monitor Processing

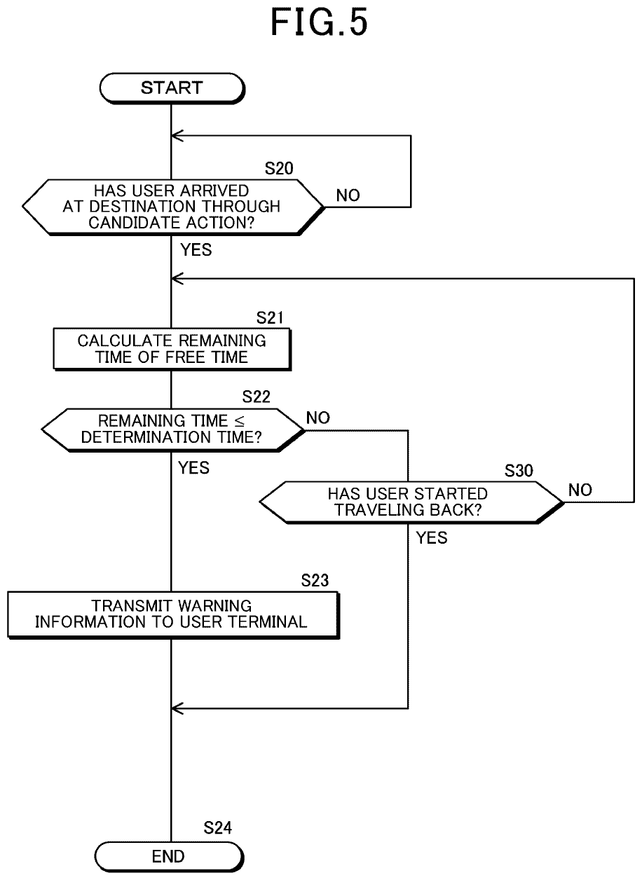

A procedure of remaining time monitor processing executed by the remaining time monitor unit 18 when the user U performs the first candidate action shown in FIG. 1 will be described in accordance with a flowchart shown in FIG. 5. In Step S20 of FIG. 5, the remaining time monitor unit 18 receives position information transmitted from the user terminal 50, and determines whether the user U has arrived at the destination through the candidate action by recognizing a current position of the user U. The user terminal 50 includes a position sensor such as a global navigation satellite system (GNSS) sensor, and transmits the position information indicating the current position of the user terminal 50 detected by the position sensor to the action suggestion system 1.

The remaining time monitor unit 18 then proceeds the processing to step S21 when the remaining time monitor unit 18 recognizes that the user U has arrived at the destination. In step S21, the remaining time monitor unit 18 determines whether a remaining time of the free time (time from current time to 16:00 being end time of free time) of the user U is equal to or shorter than a determination time obtained by adding a spare time to a required time to return to Ps (51 minutes). The remaining time monitor unit 18 then proceeds the processing to step S23 when the remaining time of the free time of the user U is equal to or shorter than the determination time, and proceeds the processing to step S30 when the remaining time of the free time of the user U is longer than the determination time.

In Step S30, the remaining time monitor unit 18 receives the position information transmitted from the user terminal 50, and determines whether the user U has started traveling back to Ps by recognizing the current position of the user U. The remaining time monitor unit 18 then proceeds the processing to step S24 when the user U has started traveling back to Ps, and ends the remaining time monitor processing. On the other hand, when the user U has not started traveling back to Ps, the remaining time monitor unit 18 proceeds the processing to step S21 and executes the processing again from step S21.

In step S23, the remaining time monitor unit 18 transmits, to the user terminal 50, warning information Ami notifying that the remaining time of the free time is running short. The user terminal 50 having received the warning information Ami displays warning information on the display indicating that the remaining time of the free time is running short, and urges the user U to return to Ps.

In the schedule of the user U shown in FIG. 2, the user U does not have much extra free time, but user U receives extra free time when, for example, another conference is running late and a start time of the conference about Topic B that the user U plans to participate in at 16:00 is changed to 16:30.

Accordingly, when the remaining time monitor unit 18 recognizes from the schedule information Sci of the user U received from the schedule server 210 that the user U has received extra free time, the remaining time monitor unit 18 may transmit, as warning processing, stay extension suggestion information to the user terminal 50 for suggesting to extend a stay duration at Pd being the destination and informing the user U of operation conditions of an available eVTOL when the stay duration is extended. The user terminal 50 having received the stay extension suggestion information displays, on the display, the stay extension suggestion information including the suggestion to extend the stay duration at Pd and the information about available transportation means when the stay duration is extended, based on the stay extension suggestion information.

Since there are also cases where the user U can adjust their plans after the free time ends, the remaining time monitor unit 18 may transmit the stay extension suggestion information to the user terminal 50 regardless of the schedule of the user U.

### 4. Other Embodiments

In the above embodiment, the free time recognition unit 12 recognizes the free time of the user U from the schedule information Sci of the user U. As another embodiment, the user U may use the user terminal 50 or another terminal device to transmit information about the free time of the user U to the action suggestion system 1, and the free time recognition unit 12 may recognize the free time of the user U by receiving and acquiring the information about the free time of the user U.

In the above embodiment, since a position at which the free time of the user U ends (free time ending position) in the schedule of FIG. 2 is Hotel X, the free time starting position and the free time ending position are the same in the example of FIG. 1 and FIG. 2. As another example, when the conference in which the user U is to participate from 16:00 is held at another Hotel Y close to Hotel X, the free time starting position and the free time ending position are different. In this case, the free time position recognition unit 13 recognizes the location of Hotel Y as the free time ending position.

The candidate action selection unit 15 then selects a candidate action that can be performed by the user U by using free time of the user U and that has Hotel X (free time starting position) as a starting point and Hotel Y (free time ending position) as an ending point. The candidate action information provision unit 16 transmits, to the user terminal 50, the candidate action information Cai relating to the candidate action selected by the candidate action selection unit 15, but in this case, the candidate action information Cai includes the travel time from the destination to Y for a plurality of travel methods. The display of the user terminal 50 then displays the travel time from Hotel X to the destination for the plurality of travel methods shown in FIG. 4 (corresponding to a first travel method according to the present disclosure), and the travel time from the destination to Hotel Y for the plurality of travel methods (corresponding to a second travel method according to the present disclosure). This allows the user U to compare each travel time of the plurality of travel methods also for the travel methods to return to the free time ending position, and select the travel method to be used.

In the above embodiment, the activity purpose recognition unit 14 recognizes the activity purpose of the user U from the profile and a past action history of the user U. As another embodiment, the user U may use the user terminal 50 or another terminal device to transmit information about the activity purpose the user U desires to the action suggestion system 1, and the activity purpose recognition unit 14 may recognize the activity purpose of the user U by receiving and acquiring the information about the activity purpose the user U desires.

In the above embodiment, the action suggestion system 1 includes the remaining time monitor unit 18. The remaining time monitor unit 18 notifies the user U having arrived at the destination Pd that the remaining time of the free time is running short, but the action suggestion system 1 may have a configuration in which the remaining time monitor unit 18 is omitted.

In the above embodiment, the action suggestion system 1 includes the transportation means reservation acceptance unit 17. The transportation means reservation acceptance unit 17 supports a reservation for a transportation means made by the user U, but the action suggestion system 1 may have a configuration in which the transportation means reservation acceptance unit 17 is omitted.

In the above embodiment, the action suggestion system according to the present disclosure is implemented as the action suggestion system 1 being a computer system that performs communication with the user terminal 50, the schedule server 210, the transportation means server 220, and the activity information server 230, a part or an entirety of a configuration of the action suggestion system according to the present disclosure may be implemented by the user terminal 50. In this case, the configuration of the action suggestion system 1 described above is realized by a processor included in the user terminal 50 executing the action suggestion app installed on the user terminal 50, thereby performing the communication between the user terminal 50 and the schedule server 210, the transportation means server 220, and the activity information server 230.

Note that FIG. 1 is a schematic diagram showing the functional configuration of the action suggestion system 1 by dividing the functional configuration according to a main processing content to facilitate understanding of the invention of the present application, and the configuration of the action suggestion system 1 may be divided differently. Further, the processing of each component may be executed by one hardware unit or may be executed by a plurality of hardware units. Further, the processing of each component shown in FIG. 3 and FIG. 5 may be executed by one program or may be executed by a plurality of programs.

### 5. Configurations Supported by Above Embodiments

The above embodiments are specific examples of the following configurations.

(Configuration 1) An action suggestion system including: a free time recognition unit that recognizes free time of a user; a free time position recognition unit that recognizes a free time starting position being a position at which the user is located when the free time starts; a candidate action selection unit that selects, as a candidate action to be suggested to the user, an action that the user can perform using the free time, the action including travel between the free time starting position and a destination by any of a plurality of travel methods and a predetermined activity at the destination; and a candidate action information provision unit that causes a display device used by the user to display an action suggestion screen displaying a required travel time between the free time starting position and the destination for each of the plurality of travel methods and a content of the predetermined activity.

According to the action suggestion system of Configuration 1, it is possible to suggest an action to the user that can be performed in the free time of the user by extracting the action in accordance with a difference in travel time depending on the travel method.

(Configuration 2) The action suggestion system according to Configuration 1 wherein the free time position recognition unit recognizes a free time ending position being a position at which the user is located when the free time ends; the candidate action selection unit selects, when the free time starting position and the free time ending position are different, an action as the candidate action, the action including travel from the free time starting position to the destination by any of a plurality of first travel methods, the predetermined activity at the destination, and travel from the destination to the free time ending position by any of a plurality of second travel methods; and the candidate action information provision unit causes, when the free time starting position and the free time ending position are different, the display device to display the action suggestion screen displaying a required travel time from the free time starting position to the destination for each of the plurality of first travel methods, a required travel time from the destination to the free time ending position for each of the plurality of second travel methods, and the content of the predetermined activity.

According to the action suggestion system of Configuration 2, when the free time starting position and the free time ending position are different, it is possible to provide the user with information about travel time by the plurality of travel methods of travel from the free time starting position to the destination and travel from the destination to the free time ending position, and to support the user in selecting a travel method.

(Configuration 3) The action suggestion system according to Configuration 1 or 2, wherein the candidate action selection unit selects the candidate action by referring to an activity database in which evaluation information about a plurality of target activities is recorded and extracting the predetermined activity from the plurality of target activities having a high rating equal to or higher than a predetermined level.

According to the action suggestion system of Configuration 3, it is possible to suggest a candidate action to the user in which a predetermined activity can be performed having a high rating.

(Configuration 4) The action suggestion system according to any one of Configurations 1 to 3 further including an activity purpose recognition unit that recognizes an activity purpose the user desires, wherein the candidate action selection unit selects the candidate action by referring to an activity database in which an activity purpose of a plurality of target activities is recorded and extracting the predetermined activity from the plurality of target activities the activity purpose of which is recorded, the predetermined activity matching the activity purpose the user desires.

According to the action suggestion system of Configuration 4, it is possible to suggest a candidate action to the user in which a predetermined activity can be performed matching an activity purpose the user desires.

(Configuration 5) The action suggestion system according to any one of Configurations 1 to 4, wherein the candidate action selection unit selects, as an action that the user can perform using the free time, an action that the user can perform within the free time or an action that the user can perform by adding a predetermined amount of time before and/or after the free time.

According to the action suggestion system of Configuration 5, it is possible to provide the user with information about a candidate action that can be performed within the free time of the user and a candidate action that can be performed by adding a predetermined amount of time before or after the free time.

(Configuration 6) The action suggestion system according to Configuration 5, wherein when a first case in which the candidate action can be performed within the free time and a second case in which the candidate action can be performed by adding the predetermined amount of time before and/or after the free time occur due to a difference between the plurality of travel methods, the candidate action information provision unit causes the display device to display the action suggestion screen displaying the travel methods in the first case and the second case together with a required travel time of the travel methods.

According to the action suggestion system of Configuration 6, it is possible to support the user in comparing between the first case in which the candidate action can be performed within the free time and the second case in which the candidate action can be performed by adding the predetermined amount of time to the free time due to a difference between the travel methods, and easily determine an action to be performed using the free time.

(Configuration 7) The action suggestion system according to any one of Configurations 1 to 6, further including a remaining time monitor unit that recognizes that the user has started the candidate action, monitors a remaining time of the free time at the destination, and causes the display device to display warning information indicating that the remaining time is running short when the remaining time is equal to or shorter than a predetermined determination time.

According to the action suggestion system of Configuration 7, it is possible to allow a user having started the candidate action and staying at the destination to recognize when to start traveling back, by providing warning information indicating that the remaining time is running short.

(Configuration 8) The action suggestion system according to Configuration 7, wherein the remaining time monitor unit causes the display device to display stay extension suggestion information including a suggestion to extend a stay duration at the destination when the remaining time is equal to or shorter than the determination time and information about the travel methods available when the stay duration at the destination is extended.

According to the action suggestion system of Configuration 7, it is possible to suggest a flexible action change to the user staying at the destination, by extending the stay duration.

(Configuration 9) The action suggestion system according to Configuration 8 further including a schedule recognition unit that recognizes a schedule of the user, wherein the remaining time monitor unit determines whether to cause the display device to display the stay extension suggestion information in accordance with plans of the user after the free time recognized from the schedule.

According to the action suggestion system of Configuration 9, it is possible to determine whether to provide the user with the stay extension suggestion information in accordance with the plans of the user after the free time.

(Configuration 10) An action suggestion method to be executed by a computer, the action suggestion method including: a free time recognition step of recognizing free time of a user; a free time starting position recognition step of recognizing a free time starting position being a position at which the user is located when the free time starts; a candidate action selection step of selecting, as a candidate action to be suggested to the user, an action that the user can perform using the free time, the action including travel between the free time starting position and a destination by any of a plurality of travel methods and a predetermined activity at the destination; and a candidate action information provision step of causing a display device used by the user to display an action suggestion screen displaying a required travel time between the free time starting position and the destination for each of the plurality of travel methods and a content of the predetermined activity.

It is possible to achieve advantageous effects similar to those of the action suggestion system of Configuration 1 through a computer executing the action suggestion method of Configuration 10.

### REFERENCE SIGNS LIST

1 action suggestion system
10 processor
11 schedule recognition unit
12 free time recognition unit
13 free time position recognition unit
14 activity purpose recognition unit
15 candidate action selection unit
16 candidate action information provision unit
17 transportation means reservation acceptance unit
18 remaining time monitor unit
20 memory
21 program
22 user DB
30 communication unit
50 user terminal
51 action suggestion screen
100 eVTOL
110 ship
120 bus
200 communication network
210 schedule server
220 transportation means server
230 activity information server
Ps free time starting position
Pd destination
U user

1. An action suggestion system comprising:
a free time recognition unit that recognizes free time of a user;
a free time position recognition unit that recognizes a free time starting position being a position at which the user is located when the free time starts;
a candidate action selection unit that selects, as a candidate action to be suggested to the user, an action that the user can perform using the free time, the action including travel between the free time starting position and a destination by any of a plurality of travel methods and a predetermined activity at the destination; and
a candidate action information provision unit that causes a display device used by the user to display an action suggestion screen displaying a required travel time between the free time starting position and the destination for each of the plurality of travel methods and a content of the predetermined activity.

2. The action suggestion system according to claim 1, wherein
the free time position recognition unit recognizes a free time ending position being a position at which the user is located when the free time ends,
the candidate action selection unit selects, when the free time starting position and the free time ending position are different, an action as the candidate action, the action including travel from the free time starting position to the destination by any of a plurality of first travel methods, the predetermined activity at the destination, and travel from the destination to the free time ending position by any of a plurality of second travel methods, and
the candidate action information provision unit causes, when the free time starting position and the free time ending position are different, the display device to display the action suggestion screen displaying a required travel time from the free time starting position to the destination for each of the plurality of first travel methods, a required travel time from the destination to the free time ending position for each of the plurality of second travel methods, and the content of the predetermined activity.

3. The action suggestion system according to claim 1, wherein
the candidate action selection unit selects the candidate action by referring to an activity database in which evaluation information about a plurality of target activities is recorded and extracting the predetermined activity from the plurality of target activities having a high rating equal to or higher than a predetermined level.

4. The action suggestion system according to claim 1, further comprising:
an activity purpose recognition unit that recognizes an activity purpose the user desires, wherein
the candidate action selection unit selects the candidate action by referring to an activity database in which an activity purpose of a plurality of target activities is recorded and extracting the predetermined activity from the plurality of target activities the activity purpose of which is recorded, the predetermined activity matching the activity purpose the user desires.

5. The action suggestion system according to claim 1, wherein
the candidate action selection unit selects, as an action that the user can perform using the free time, an action that the user can perform within the free time or an action that the user can perform by adding a predetermined amount of time before and/or after the free time.

6. The action suggestion system according to claim 4, wherein
when a first case in which the candidate action can be performed within the free time and a second case in which the candidate action can be performed by adding the predetermined amount of time before and/or after the free time occur due to a difference between the plurality of travel methods, the candidate action information provision unit causes the display device to display the action suggestion screen displaying the travel methods in the first case and the second case together with a required travel time of the travel methods.

7. The action suggestion system according to claim 1, further comprising:
a remaining time monitor unit that recognizes that the user has started the candidate action, monitors a remaining time of the free time at the destination, and causes the display device to display warning information indicating that the remaining time is running short when the remaining time is equal to or shorter than a predetermined determination time.

8. The action suggestion system according to claim 7, wherein
the remaining time monitor unit causes the display device to display stay extension suggestion information including a suggestion to extend a stay duration at the destination when the remaining time is equal to or shorter than the determination time and information about the travel methods available when the stay duration at the destination is extended.

9. The action suggestion system according to claim 8, further comprising:
a schedule recognition unit that recognizes a schedule of the user, wherein
the remaining time monitor unit determines whether to cause the display device to display the stay extension suggestion information in accordance with plans of the user after the free time recognized from the schedule.

10. An action suggestion method to be executed by a computer, the action suggestion method comprising:
a free time recognition step of recognizing free time of a user;
a free time starting position recognition step of recognizing a free time starting position being a position at which the user is located when the free time starts;
a candidate action selection step of selecting, as a candidate action to be suggested to the user, an action that the user can perform using the free time, the action including travel between the free time starting position and a destination by any of a plurality of travel methods and a predetermined activity at the destination; and
a candidate action information provision step of causing a display device used by the user to display an action suggestion screen displaying a required travel time between the free time starting position and the destination for each of the plurality of travel methods and a content of the predetermined activity.
